(19) United States
(12) Patent Application Publication
(10) Pub. No.: US 2012/0011728 A1
(43) Pub. Date: Jan. 19, 2012

(54) UTILITY KNIFE AND FASTENER THEREOF

(75) Inventor: Brian Keers, Terryville, CT (US)

(73) Assignee: STANLEY BLACK & DECKER, INC., New Britain, CT (US)

(21) Appl. No.: 12/839,107

(22) Filed: Jul. 19, 2010

(51) Int. Cl. B26B 3/06

(52) U.S. Cl. 30/164

(57) ABSTRACT

A utility knife includes a handle and a connector member. The handle includes a first handle portion and a second handle portion. The connector member is constructed and arranged to releasably connect the first handle portion with the second handle portion. The connector member includes a head portion and a shaft portion extending from the head portion. The head portion includes finger engaging portions extending outwardly for engagement by the fingers of a user, and a groove disposed on a surface of the head portion that is adapted to receive a tool. The connector member is constructed and arranged to be rotated either by engaging the tool in the groove or by manually moving the finger engaging portions. The connector member is constructed and arranged to remain attached to the first handle portion if the first handle portion is separated from the second handle portion.

### BACKGROUND OF THE INVENTION

### Field of the Invention

The present invention relates to utility knives.

Utility knives have been developed for use in various applications such as, for example, construction, packaging and shipping, carpet installation, as well as other purposes. One form of utility knife includes two mating halves that are secured to one another by a fastening mechanism. A blade is fixed between the two halves.

The present invention provides improvements over the prior art utility knives and their fasteners.

### SUMMARY

One aspect of the invention relates to a utility knife that includes a handle and a connector member. The handle includes a first handle portion and a second handle portion. The connector member is constructed and arranged to releasably connect the first handle portion with the second handle portion. The connector member includes a head portion and a shaft portion extending from the head portion. The head portion includes finger engaging portions extending outwardly for engagement by the fingers of a user, and a groove disposed on a surface of the head portion that is adapted to receive a tool. The connector member is constructed and arranged to be rotated either by engaging the tool in the groove or by manually moving the finger engaging portions. The connector member is constructed and arranged to remain attached to the first handle portion if the first handle portion is separated from the second handle portion.

These and other aspects of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one example of the invention, the structural components illustrated herein can be considered drawn to scale. It is to be expressly understood, however, that many other configurations are possible and that the drawings are for the purpose of example, illustration and description only and are not intended as a definition or to limit the scope of the invention. It shall also be appreciated that the features of one embodiment disclosed herein can be used in other embodiments disclosed herein. As used in the specification and in the claims, the singular form of “a”, “an”, and “the” include plural referents unless the context clearly dictates otherwise.

### BRIEF DESCRIPTION OF THE DRAWINGS

FIG. 1 shows a side elevational view, showing the left-hand side, of a utility knife in accordance with an embodiment of the present invention;

FIG. 2 shows a perspective view of a connector member that releasably connects first handle portion and second handle portion of the utility knife in accordance with an embodiment of the present invention;

FIG. 3 shows a top elevational view of the connector member in accordance with an embodiment of the present invention;

FIG. 4 shows a bottom elevational view of the connector member in accordance with an embodiment of the present invention;

FIG. 5 shows a front elevational view of the connector member in accordance with an embodiment of the present invention;

FIG. 6 shows a side elevational view of the connector member in accordance with an embodiment of the present invention;

FIG. 7 is a cross-sectional view taken through the line 7-7 in FIG. 1;

FIG. 8 shows a procedure in which the connector member is rotated by engaging a tool in a groove disposed on head portion in accordance with an embodiment of the present invention;

FIG. 9 shows a procedure in which the connector member is rotated by manually moving finger engaging portions that extend outwardly from the connector member in accordance with an embodiment of the present invention; and

FIG. 10 shows a procedure in which the connector member remains attached to first handle portion if the first handle portion is separated from second handle portion.

### DETAILED DESCRIPTION OF THE INVENTION

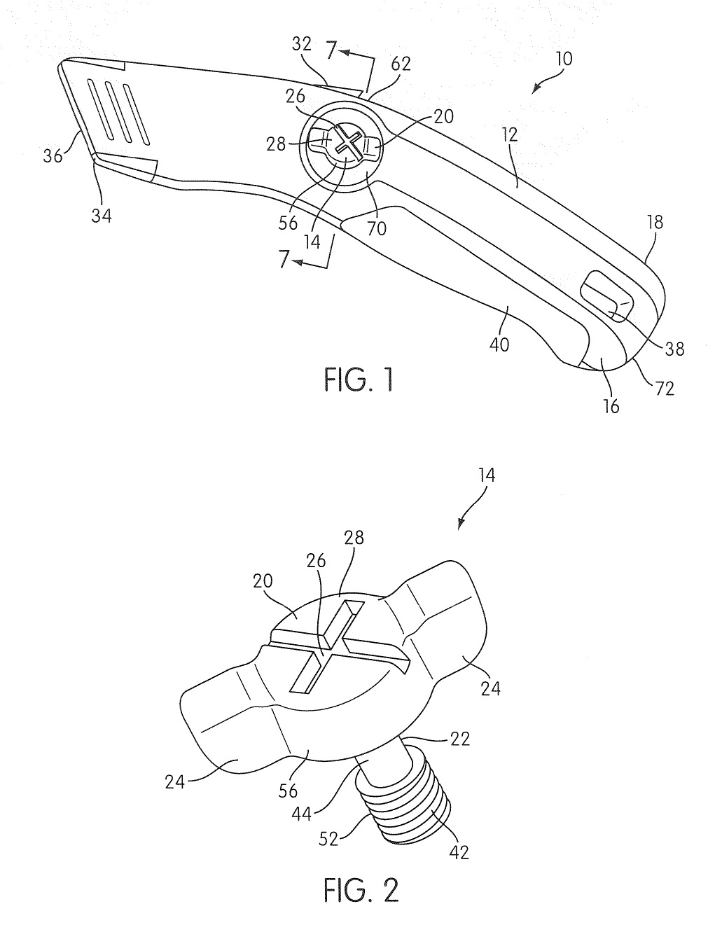

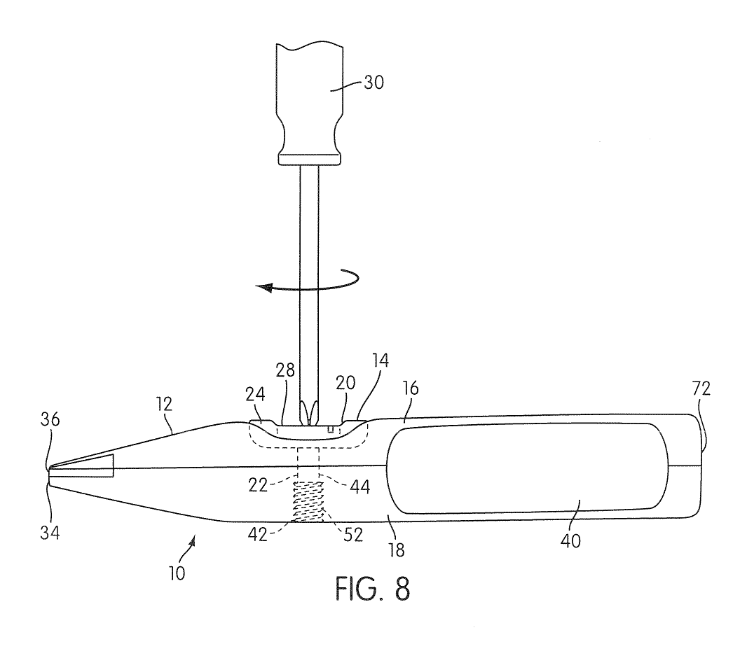

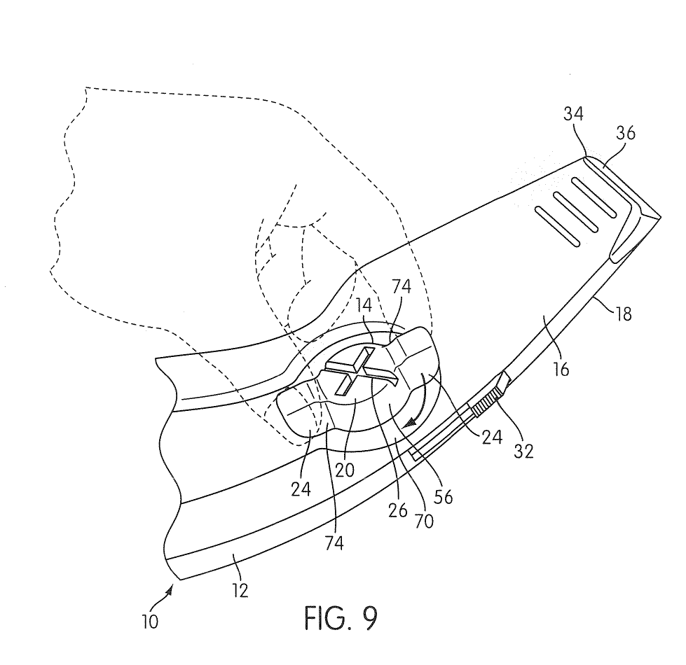

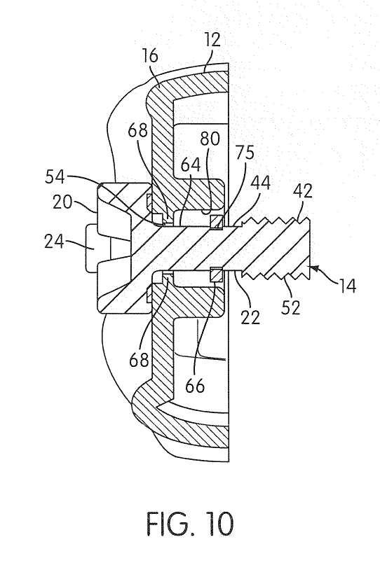

FIG. 1 shows a utility knife 10 in accordance with an embodiment of the present invention. The utility knife 10 includes a handle 12 and a connector member 14. FIG. 2 shows a perspective view of the connector member 14. The handle 12 includes a first handle portion 16 and a second handle portion 18. The connector member 14 is constructed and arranged to releasably connect the first handle portion 16 with the second handle portion 18. The connector member 14 includes a head portion 20 and a shaft portion 22 extending from the head portion 20. The head portion 20 includes finger engaging portions 24 extending outwardly for engagement by the fingers of a user, and a groove 26 disposed on a surface 28 of the head portion 20 that is adapted to receive a tool 30 (as shown in FIG. 8). As shown in FIGS. 8 and 9, the connector member 14 is constructed and arranged to be rotated either by engaging the tool 30 in the groove 26 or by manually moving the finger engaging portions 24. As shown in FIG. 10, the connector member 14 is constructed and arranged to remain attached to the first handle portion 16 if the first handle portion 16 is separated from the second handle portion 18.

The handle 12 is made of an appropriate metal (such as aluminum or steel) or other material of suitable strength and is comprised of two mating handle portions 16 and 18. In one embodiment, the handle 12 is made of molded plastic material. As noted above, the first handle portion 16 and the second handle portion 18 are releasably connected using the connector member 14 to form the handle 12.

In one embodiment, the exterior surface of the handle 12 is suitably contoured to assist the user in holding onto the handle 12 and to facilitate employment of a blade (not shown) to perform various cutting tasks. Specifically, in one embodiment, the top portion of the handle 12 is contoured or arranged, preferably slightly convexly, to more comfortably accommodate the palm of the user's hand.

In one embodiment, the interior of the handle 12 is configured to receive a blade holder assembly (not shown) that is constructed and arranged to hold a blade at a position of use, wherein the blade projects through an opening 36 at the front end 34 of the handle 12, and to retract the blade into the handle 12. In other words, the blade holder assembly is movable between a retracted position wherein the blade is disposed within the handle 12 and an extended position wherein the blade protrudes outwardly (e.g., from the opening 36 at the front end 34) from the handle 12 to enable a cutting operation. The extended position may include not only a fully extended position, but may also include at least one intermediate position wherein the blade can be releasably locked at a position in which only a part of the possible extent of the blade extends from the handle. A manually engageable member 32 is slidably disposed on the handle 12 and is operatively connected with the blade holder assembly such that movement of the manually engageable member 32 moves the blade holder assembly between the extended and retracted positions.

In various embodiments, the structure of the blade holder assembly can be any of the types described in commonly assigned U.S. Pat. Nos. 4,586,256; 6,192,589; 6,971,178; and 7,296,354, just for example. Each of these patents are hereby incorporated by reference in their entirety.

In one embodiment, the first and the second handle portions 16 and 18 cooperate to form an upper slot for slidable movement of the manually engageable member 32 of the blade holder assembly (not shown), and the opening 36 at the front end 34 that is sized to allow the blade mounted in the blade holder assembly to move in and out of the handle 12.

In one embodiment, the first and the second handle portions 16 and 18 include attachment apertures 38 that are constructed and arranged to facilitate the attachment of the utility knife 10 to a tool belt or to provide a way to hang the knife 10 for storage when not in use.

In one embodiment, a lower gripping member 40 is mountable on the handle 12 in a position to engage the fingers of a gripping hand to provide the fingers with a comfortable gripping surface. In one embodiment, the lower gripping member 40 may be made of a suitable molded plastic material. In another embodiment, the lower gripping member 40 may be made of a suitable molded plastic material and is coated with a layer of an elastomeric material, such as rubber. In one embodiment, a fastener member may be used to connect the lower gripping member 40 to the first handle portion 16 and the second handle portion 18.

In one embodiment, a blade having a trapezoidal shape may be used in the utility knife 10. A longest side of the trapezoidal blade includes a linear cutting edge, and a shorter side of the trapezoidal blade includes at least one locating notch that is configured to mate with a complementary blade engaging protrusion provided on the blade holder assembly to prevent the blade from moving longitudinally forwardly or rearwardly out of engagement with the blade holder assembly, as known in the art. Other cutting edges and blade shapes can also be used (e.g., a hook type blade).

In one embodiment, a blade storage compartment or chamber is disposed in the handle 12, and is configured to carry a plurality of spare blades. In one embodiment, the blade storage compartment is formed in a rear portion of the handle 12 for housing spare blades and is accessible for the removal of spare blades stored therein.

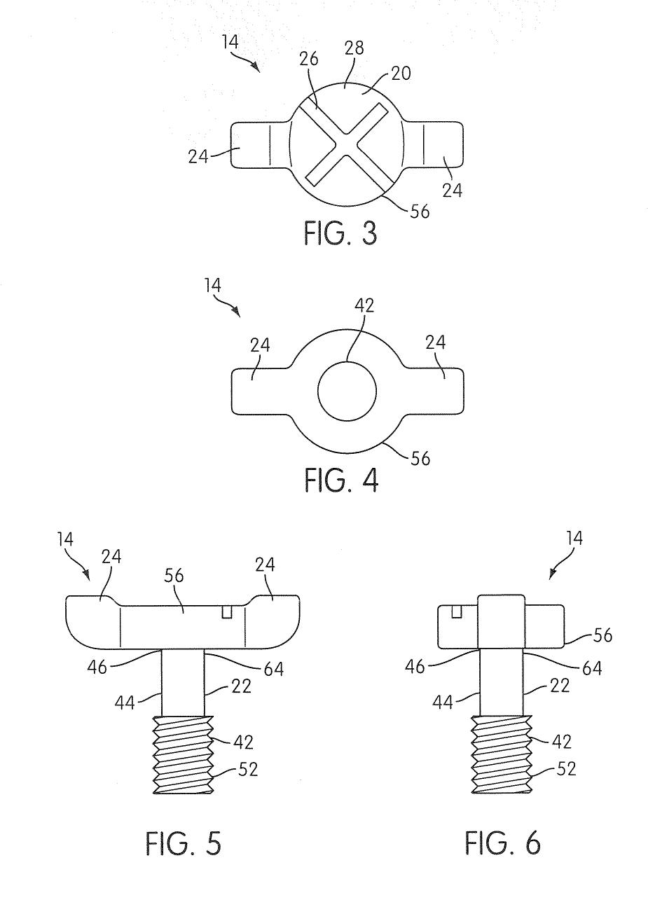

FIG. 2 is a perspective view, FIG. 3 is a top elevational view, FIG. 4 is a bottom elevational view, FIG. 5 is a front elevational view, and FIG. 6 is a side elevational view of the connector member 14 to illustrate various views of the connector member 14 in accordance with one embodiment.

The connector member 14 is constructed and arranged to releasably connect the first handle portion 16 with the second handle portion 18. In one embodiment, as shown in FIG. 1, the connector member 14 is positioned in a middle portion or section 62 of the handle 12. In another embodiment, the connector member 14 is positioned closer to the front end 34 of the handle 12 than rear end 72 of the handle 12.

The handle 12 includes a recessed portion 70 that is configured to receive the connector member 14 therein. In other words, the head portion 20 along with the finger engaging portions 24 of the connector member 14 lie in the recessed portion 70 of the handle 12. In one embodiment, the recessed portion 70 is disposed in the middle portion of the first handle portion 16.

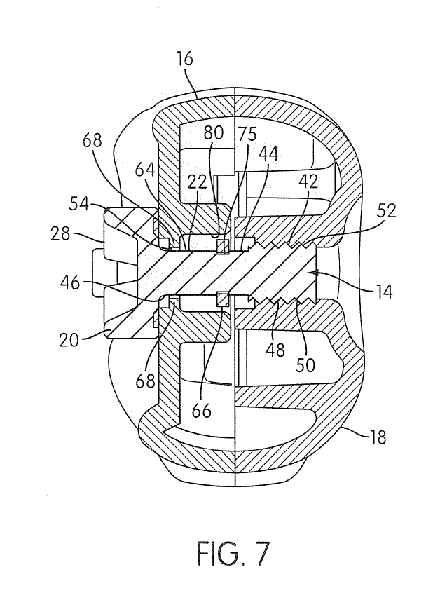

The connector member 14 includes the head portion 20 and the shaft portion 22. The shaft portion 22 is constructed and arranged to extend axially downwards from the head portion 20. In other words, as shown in FIG. 7, the head portion 20 is disposed at one end 46 of the shaft portion 22. The circumference (or perimeter) of the head portion 20 is greater than the shaft portion 22. The diameter of the head 20 is larger than that of the shaft portion 22 as well.

The head portion 20 includes the finger engaging portions 24 extending outwardly for engagement by the fingers of a user. In one embodiment, the finger engaging portions 24 extend laterally and outwardly from a circumferential surface 56 of the head portion 20.

In the illustrated embodiment, as shown in FIGS. 1 and 2, two finger engaging portions 24 are disposed on opposing sides of the head portion 20. It is contemplated, however, that the number of the finger engaging portions 24 that are disposed on the head portion 20 can vary significantly in number. For example, in one embodiment, one, three, four or more finger engaging portions may extend outwardly from the circumferential surface 56 of the head portion 20.

In one embodiment, each finger engaging portion 24 includes a finger engaging surface 74 that is configured to engage with a finger of the user as the connector member 14 is rotated. For example, in the illustrated embodiment, where the connector member 14 includes two finger engaging portions 24, thumb of the user is engaged with the finger engaging surface 74 of one of the finger engaging portion 24 and forefinger (or pointer finger) of the user is engaged with the finger engaging surface 74 of the other of the finger engaging portion 24.

In one embodiment, the manual movement of the finger engaging portions 24 enable the rotation of the connector member 14 without tools. In other words, the connector member 14 may be easily rotated (i.e., to tighten or loosen the connector member 14) by moving the finger engaging portions 24 by hand without tools.

In one embodiment, the shaft portion 22 is generally cylindrical in shape and includes a threaded portion 42 and a non-threaded portion 44. The threaded portion 42 is constructed and arranged to be engaged with a mating, hollow boss portion 48 (as shown in FIG. 7) in the second handle portion 18 so as to releasably connect the first handle portion 16 with the second handle portion 18. In one embodiment, the hollow boss portion 48 includes an internally threaded portion 50 (as shown in FIG. 7). In one embodiment, the mating, internally screw-threaded hollow boss 48 forms an integral part of the second handle portion 18. In one embodiment, the threaded portion 42 includes an externally threaded portion 52.

In one embodiment, as shown in FIG. 7, the non-threaded portion 44 is constructed and arranged to be received in an opening 54 in the first handle portion 16 and to remain attached to the first handle portion 16 if the first handle portion 16 is separated from the second handle portion 18.

In one embodiment, the first handle portion 16 includes a threaded (e.g., internally) portion 68 disposed around the opening 54. In other words, the threaded portion 68 is in the form of an annular ring that is, for example, cast around the opening 54 in the first handle portion 16. The internally threaded portion 68 is constructed and arranged to enable the connector member 14 to be screwed in through the opening 54 in the first handle portion 16. Once the threaded portion 42 of the connector member 14 is inserted through the opening 54 in the first handle portion 16, the connector member 14 remains attached to the first handle portion 16 unless the user takes intentional steps to remove it from the first handle portion 16. Specifically, the connector member 14 may be removed from the first handle portion 16 only by pulling back the connector member 14 (to take up the slack of the unthreaded shaft portion) and then unscrewing it at the same time.

In one embodiment, as shown in FIG. 7, the connector member 14 optionally includes a fastener member 66 that prevents the connector member 14 from being removed from the first handle portion 16 (unless the fastener member 66 is physically removed from the connector member 14). In one embodiment, the fastener member 66 may be disposed near a portion 64 of the shaft portion 22. In one embodiment, the first handle portion 16 includes a groove 75 disposed near the portion 64 of the shaft portion 22, where the groove 75 is constructed and arranged to receive the fastener member 66 therein. The fastener member 66, when in use, is configured to provide an interference fit onto the groove 75.

In one embodiment, the fastener member 66 may be circlip or snap ring. The circlip or snap ring 66 generally includes a semi-flexible ring with open ends which can be snapped onto the shaft portion 22 of the connector member 14, and is sized to be able to fit into the groove 75 disposed near the portion 64 of the shaft portion 22. Such circlip or snap ring is generally configured to permit the rotation of the connector member 14 and to prevent lateral movement of the connector member 14 that would separate the connector member 14 from the first handle portion 16.

In one embodiment, after the connector member 14 is screwed through the opening 54, the fastener member 66 is forced onto the shaft portion 22. The fastener member 66 then prevents the connector member 14 from being pulled back out through the opening 54 (irrespective of whether the opening 54 is internally threaded (which is an option) or not). When the connector member 14 is held captive to the first handle portion 16 using the fastener member 66, the fastener member 66 may be disposed in the groove 75 and may also be forced out of the groove 75 by first pulling back on the head of the connector member 14 and then forcing it forwards.

The shaft portion 22 extends through the opening 54 in the first handle portion 16 into the interior of the handle 12 and screw-threadedly engages the boss portion 48 of the second handle portion 18.

The head portion 20 includes the groove 26 disposed on the top surface 28 of the head portion 20 that is adapted to receive a tool (e.g., as shown by reference numeral 30 in FIG. 8). In the illustrated embodiment, as shown in FIGS. 2 and 3, the groove 26 includes cross shaped configuration. In other words, the groove 26 has a combination of single straight slot and Phillips-type shaped slot. In the illustrated embodiment, as shown in FIGS. 2 and 3, the groove 26 is configured to receive either a flat head screw driver (i.e., in the single straight slot) or a cross head screw driver (or a Phillips screw driver) (i.e., in the Phillips-type shaped slot).

Although the illustrated groove includes a cross shaped configuration, it is contemplated that grooves having other shaped configurations that are constructed and arranged to accommodate one or more kinds of screw driver format may be used. For example, the groove may be constructed and arranged to receive a flat head screw driver and a square screw driver (or Robertson screw driver), a cross head screw driver (or a Phillips screw driver) and a square screw driver (or Robertson screw driver), a flat head screw driver and a star (i.e., six point) screw driver, a Pozidriv® (i.e., positive drive) screw driver and a square screw driver (or Robertson screw driver), a Pozidriv® (i.e., positive drive) screw driver and a flat head screw driver, or a flat head screw driver, a square screw driver (or Robertson screw driver), and a cross head screw driver (or a Phillips screw driver).

FIG. 7 is a cross-sectional view of the utility knife 10 taken through the line 7-7 in FIG. 1. The connector member 14 is first mounted through the opening 54 in the first handle portion 16 so as to attach the connector member 14 to the first handle portion 16.

In one embodiment, as noted above, the fastener member 66 prevents any lateral movement of the connector member 14. The connector member 14 (i.e., attached to the first handle portion 16) is threaded into the hollow boss portion 48 in the second handle portion 18. The fastener member 66 permits the rotation of the connector member 14 as the connector member 14 is threaded into the hollow boss portion 48 in the second handle portion 18.

FIG. 8 shows a procedure in which the connector member 14 is rotated by engaging the tool 30 in the groove 26 disposed on the head portion 20 in accordance with an embodiment of the present invention. In one embodiment, either a flat head screw driver (i.e., received in the single straight slot of the groove 26) or a cross head screwdriver (or a Phillips screw driver) (i.e., received in the Phillips-type shaped slot of the groove 26) may be used to rotate the connector member 14. As is known in the art, the tool 30 received in the groove 26 rotates the connector member 14 in a clock-wise direction to releasably connect (by tightening the connector member 14) the first handle portion 16 of the utility knife 10 to the second handle portion 18 of the utility knife 10, and in a counter-clockwise direction for releasing or disassembling (by loosening the connector member 14) the first handle portion 16 from the second handle portion 18 of the utility knife 10.

FIG. 9 shows a procedure in which the connector member 14 is rotated by manually moving finger engaging portions 24 that extend outwardly from the connector member 14 in accordance with an embodiment of the present invention. The manual movement of the finger engaging portions 24 enable the rotation of the connector member 14. For example, in the illustrated embodiment with two finger engaging portions 24, thumb of the user is engaged with the finger engaging surface 74 of one of the finger engaging portion 24 and forefinger (or pointer finger) of the user is engaged with the finger engaging surface 74 of the other of the finger engaging portion 24 to move/rotate the finger engaging portions. The manual movement of the finger engaging portions 24 in a clock-wise direction releasably connects the first handle portion 16 of the utility knife 10 to the second handle portion 18 of the utility knife 10, and in a counter-clockwise direction releases/disassembles the first handle portion 16 from the second handle portion 16 and 18 of the utility knife 10. Therefore, the connector member 14 with the finger engaging portions 24 enables quick assembly or disassembly of the utility knife 10, without the need for any tools.

FIG. 10 shows a procedure in which the connector member 14 remains attached to first handle portion 16 if the first handle portion 16 is separated from second handle portion 18. As noted above, once the threaded portion 42 of the connector member 14 is inserted through the opening 54 in the first handle portion 16, the connector member 14 remains attached to the first handle portion 16. As noted above, the connector member 14 may then be removed from the first handle portion 16 by pulling back and unscrewing the connector member 14 at the same time. After the connector member 14 is mounted through the opening 54 in the first handle portion 16, the fastener member 66 is optionally disposed in the groove or notch 75 of the shaft portion 22 so as to prevent any lateral movement of the connector member 14 and permit the rotation of the connector member 14 as the connector member 14 is threaded into the hollow boss portion 48 in the second handle portion 18.

In another embodiment, it is contemplated that the fastener member may be in the form of flexible projections that are integrally formed on the connector member. In such embodiment, the flexible projections deform as they pass through the opening 54 in the first handle portion 16, and return back to their original position after they pass through the opening 54. When the flexible projections return back to their original position (i.e., after they pass through the opening 54 in the first handle portion 16), the flexible projections enable the connector member 14 remain attached to the first handle portion 16 (i.e., by preventing any lateral movement of the connector member 14). In other words, the flexible projections of the fastener member engage with a surface 80 of the first handle portion 16 to prevent any lateral movement of the connector member 14.

One skilled in the art will understand that the embodiment of the utility knife 10 shown in the figures and described above is exemplary only and not intended to be limiting. It is within the scope of the invention to provide any known utility knife with any or all of the features of the present invention. For example, the connector member constructed according to the principles of the present invention can be applied to any known utility knife.

Although the invention has been described in detail for the purpose of illustration, it is to be understood that such detail is solely for that purpose and that the invention is not limited to the disclosed embodiments, but, on the contrary, is intended to cover modifications and equivalent arrangements that are within the spirit and scope of the appended claims. In addition, it is to be understood that the present invention contemplates that, to the extent possible, one or more features of any embodiment can be combined with one or more features of any other embodiment.

What is claimed is:

1. A utility knife, comprising:
a handle having a first handle portion and a second handle portion; and
a connector member constructed and arranged to releasably connect the first handle portion with the second handle portion, the connector member includes a head portion and a shaft portion extending from the head portion;
wherein the head portion includes finger engaging portions extending outwardly for engagement by the fingers of a user, and a groove disposed on a surface of the head portion that is adapted to receive a tool;
wherein the connector member is constructed and arranged to be rotated either by engaging the tool in the groove or by manually moving the finger engaging portions; and
wherein the connector member is constructed and arranged to remain attached to the first handle portion if the first handle portion is separated from the second handle portion.

2. The utility knife of claim 1, wherein the connector member is a rotatable threaded screw.

3. The utility knife of claim 1, wherein the shaft portion comprises a threaded portion and a non-threaded portion, the threaded portion is constructed and arranged to be engaged with a mating, hollow boss portion in the second handle portion so as to releasably connect the first handle portion with the second handle portion.

4. The utility knife of claim 3, wherein the hollow boss portion includes an internally threaded portion.

5. The utility knife of claim 3, wherein the threaded portion includes an externally threaded portion.

5. The utility knife of claim 1, wherein the connector member is constructed and arranged to be received in an opening in the first handle portion and to remain in the opening if the first handle portion is separated from the second handle portion.

6. The utility knife of claim 1, wherein the connector member remains attached to the first handle portion using a fastener member.

7. The utility knife of claim 6, the fastener portion is disposed on a proximal end of the shaft portion.

8. The utility knife of claim 1, wherein the tool is a flat head screw driver.

9. The utility knife of claim 1, wherein the tool is a Phillips screw driver.

10. The utility knife of claim 1, wherein the groove is constructed and arranged to receive either a flat head screw driver or a Phillips screw driver.

11. The utility knife of claim 5, wherein the connector member is screwed through a threaded portion of the first handle portion, the threaded portion disposed around the opening in the first handle portion.
